(19) United States
(12) Patent Application Publication
(10) Pub. No.: US 2025/0158474 A1
(43) Pub. Date: May 15, 2025

(54) ELECTRIC MOTOR, IN PARTICULAR A RADIATOR FAN MOTOR

(71) Applicant: Brose Fahrzeugteile SE & Co. Kommanditgesellschaft, Würzburg, Würzburg (DE)

(72) Inventors: Christian WAGENBRENNER, Würzburg (DE); Milos GVOZDEN, Belgrade (RS); Vladimir BOZICKOVIC, Pancevo (RS)

(21) Appl. No.: 19/021,600

(22) Filed: Jan. 15, 2025

Related U.S. Application Data
(63) Continuation of application No. PCT/EP2023/069511, filed on Jul. 13, 2023.

(30) Foreign Application Priority Data
Jul. 15, 2022 (DE) 10 2022 207 246.4

(51) Int. Cl. H02K 5/10; B60K 11/02; H02K 3/52; H02K 11/33; H02K 21/22

(52) U.S. Cl. CPC H02K 5/10; H02K 3/522; H02K 11/33; H02K 21/22; B60K 11/02; H02K 2203/09

(57) ABSTRACT

An electric motor includes a motor carrier, an electronics compartment, a stator secured to the motor carrier and having a stator winding, and a rotor surrounding the stator. The stator has a stator main body with an annular main body part and radially outwardly directed stator teeth. A coil or winding insulating part is arranged on the stator main body. The main body part forms a receiving or mounting space in which contact pins are arranged which are/can be contacted with the stator winding and which can be guided into the electronics compartment via sealing elements in through-openings of the motor carrier. The sealing elements are mechanically pretensioned by the stator secured to the motor carrier or by the stator main body and/or by the coil or winding insulating part.

### CROSS-REFERENCE TO RELATED APPLICATION

This application is a continuation, under 35 U.S.C. § 120, of copending International Patent Application PCT/EP2023/069511, filed Jul. 13, 2023, which designated the United States; this application also claims the priority, under 35 U.S.C. § 119, of German Patent Application DE 10 2022 207 246.4, filed Jul. 15, 2022; the prior applications are herewith incorporated by reference in their entirety.

### FIELD AND BACKGROUND OF THE INVENTION

The invention relates to an electric motor, in particular a brushless external rotor motor, preferably a radiator fan motor of a motor vehicle.

An electric motor of this type usually contains a rotor that is rotatably mounted in relation to a fixed stator. In a brushless electric motor, the stator is equipped with a stator or rotating field winding, which, by applying thereto an alternating current, generates a rotating magnetic field. The rotor is usually fitted with permanent magnets, which generate a rotor magnetic field that interacts with rotating field of the stator.

In a brushless electric motor, the alternating current intended to supply the stator winding is usually generated by a converter (inverter). In smaller electric motors, this converter and the associated control electronics are often housed in an electronics compartment that is integrated in the electric motor or its motor housing. The control electronics (motor electronics) must be protected from moisture, which is why such electric motors, for example those used as radiator fan motors in motor vehicles, place comparatively high demands on the tightness of the electronics compartment. In addition, the stator winding should be reliably electrically insulated from the stator main body, which is often constructed as a laminated core formed of stacked laminations.

A brushless electric motor known from European patent EP 2 852 035 B1, corresponding to U.S. patent Ser. Nos. 10/734,859 and 10/734,860, and configured as an internal rotor (motor), in particular a radiator fan motor, contains a rotor mounted rotatably relative to a stator and a motor carrier which contains an electronics compartment sealed or closable with an electronics compartment lid for accommodating converter electronics. This contains a printed circuit board equipped with passive and active components and also with power semiconductors interconnected in a bridge circuit. The sealing concept of the known electric motor comprises sealing elements that allow the winding or connection ends, serving as phase connections, of the stator-side rotating field winding formed from coils, to pass through the electronics compartment in a sealed manner. Sealing elements made of a two-component plastic are provided for this purpose and comprise a hard and a comparatively soft sealing component as a one-piece component.

In the assembled state, the sealing elements with their comparatively soft sealing component, which can be formed in the manner of a labyrinth seal, sit in through-openings that are made in the motor carrier in the region of the electronics compartment base. The comparatively hard support components of the sealing elements protrude from the support side of the motor carrier facing the stator and are seated axially above the stator-side plastics sheath in receiving pockets located therein. For reliable sealing of the winding ends at their exit points from the soft sealing component, sealing sleeves are molded onto these, which enclose the respective winding end in a sealing manner.

### SUMMARY OF THE INVENTION

The invention therefore addresses the problem of specifying an electric motor in external rotor motor design, the phase contacts of which are reliably sealed, preferably with sufficient (mechanical) pretension of used sealing elements or sealing systems. In particular, as few component parts as possible should be employed or used for this purpose.

This problem is solved in accordance with the invention by the features of the independent claim. Advantageous variants, embodiments and developments are the subject of the dependent claims.

With the foregoing and other objects in view there is provided, in accordance with the invention, an electric motor. The electric motor includes sealing elements and a motor carrier having an electronics compartment for accommodating motor electronics. The motor carrier has through-openings and the sealing elements are disposed in the through-openings. A stator is fastened to the motor carrier and has a stator winding and a stator main body with an annular main body part and radially outwardly directed stator teeth. A coil or winding insulation is disposed on a side of the stator facing the motor carrier or on the side of the stator facing the motor carrier and on a side facing away from the motor carrier on the stator main body thereof. The annular main body part of the stator main body forms a receiving or mounting space, in which axially oriented contact pins are disposed which make contact or can make contact with the stator winding and are guided into the electronics compartment via the sealing elements in the through-openings of the motor carrier. The sealing elements are mechanically pretensioned by means of the stator fastened to the motor carrier or by means of the stator main body and/or by means of the coil or winding insulation. The electric motor further has a rotor that circulates around the stator about a rotation axis.

The brushless electric motor in external rotor motor design provided and set up in particular for a radiator fan motor of a motor vehicle has a, in particular, plate-like or plate-shaped motor carrier (a motor carrier plate) with an electronics compartment for accommodating electronics (converter electronics) and a stator fastened to the motor carrier, in particular fastened by screws, and a rotor circulating around it.

Suitably, the rotor has a pot-shaped rotor housing with permanent magnets arranged on the inside of the ring or housing wall. The rotor is mounted so as to be rotatable about a motor, which is preferably formed as a rigid rotation axis, for example a rigid pivot bolt, fixed in the motor carrier, for example cast or molded into it.

The stator of the electric motor, which is embodied as an external rotor motor, is arranged on the support side of the motor carrier opposite the electronics compartment. The stator has a stator main body, which is preferably designed as a laminated core formed of stacked stator plates or laminations. The stator or its stator main body has a preferably annular main body portion and stator teeth arranged on the outside of the ring and directed radially outwards. Coils of a stator winding (rotating field winding) are arranged on these stator teeth with at least one coil or winding insulation interposed. In the embodiment of the stator main body formed of laminations, these are substantially formed from a laminated ring with star-shaped tooth laminations molded on the outer circumference.

Coil or winding insulation is arranged on the stator main body on the side of the stator facing the motor carrier or on the side facing the motor carrier and on the side of the stator facing away from the motor carrier. The coil or winding insulation arranged on the stator main body on the side of the stator facing the motor carrier is also referred to below as the lower coil or winding insulation. The coil or winding insulation arranged on the stator main body on the side of the stator facing away from the motor carrier is also referred to below as the upper coil or winding insulation.

The annular main body part of the stator main body forms a receiving or mounting space in which a number of axially oriented contact pins are arranged that make contact or can make contact with the stator winding. These pins are guided into the electronics compartment via sealing elements, wherein the sealing elements are inserted into through-openings in the motor carrier. The contact pins suitably form the phase connections that are routed to the motor electronics and serve to energize the stator winding. It is expedient to provide three such contact pins for a three-phase stator winding.

The sealing elements are mechanically pretensioned by means of the stator main body and/or by means of the coil or winding insulation preferably provided. In other words, the sealing elements are mechanically pretensioned by means of the stator attached to the motor carrier. Therefore, no additional components or structural elements are required for the mechanical pretensioning of the sealing elements provided for the (phase) contact pins, which leads in particular to cost savings.

The stator main body on the annular main body part preferably has radial lugs aligned with respective through-openings of the motor carrier, wherein the respective, radially inwardly directed radial lug has a through-opening for the associated contact pin. The radial lugs can serve directly or indirectly via the coil or winding insulation for (mechanical) pretensioning of the sealing elements for the contact pins.

The radial lugs are particularly preferably (only) formed by a number of laminations of the stator main body that is smaller than the total number of laminations of the stator main body. For example, such lug portions are formed on 10% to 40%, preferably on 15% to 30%, particularly preferably on 20%, of successive laminations, which form the respective radial lug for the corresponding contact pin in the laminations stack (laminated core) of the stator main body.

In an advantageous embodiment, the coil or winding insulation has a number of axially raised insulating pins corresponding to the number of contact pins, which insulating pins protrude into the receiving or mounting space formed by the annular main body part of the stator main body and through which the respective contact pin passes. Conveniently, the insulating pins of the (lower) coil or winding insulation are assigned to the radial lugs of the stator main body and fit into the through-openings of the latter.

The insulating pins are suitably molded onto radially inwardly facing lugs of the (lower) coil or winding insulation. For this purpose, the coil or winding insulation has, in particular, an inner ring on which the lugs projecting into the mounting or receiving space are molded. In the assembled state, the lugs of the (lower) coil or winding insulation preferably lie against the radial lugs arranged on the annular main body part of the stator main body on the one hand and against the associated sealing elements directly or via hollow-cylindrical molded parts on the other.

According to a further advantageous embodiment, the through-openings of the motor carrier provided to accommodate the sealing elements for the contact pins have a conical or cone-shaped (frustoconical) opening portion that tapers towards the electronics compartment. Additionally or alternatively, the respective sealing element has a number of radial ribs on the outer circumference and/or a conical or frustoconical shape. The sealing elements are suitably frustoconical or conical. Suitably, a cylindrical opening portion adjoins the conical or cone-shaped opening portion in the respective through-opening of the motor carrier. The sealing elements can preferably have a shape adapted to this.

The contact pins are expediently contacted, for example welded, with connection contacts, in particular busbar-like connection contacts. The connection contacts are suitably electrically conductively connected to winding ends or winding loops of the stator winding.

Particularly preferably, the stator is fastened to the motor carrier by means of fastening elements, for example screws, while at the same time generating the pretension on or for the sealing elements through which the contact pins pass. Suitably, the stator main body has fastening lugs with through-openings for the fastening elements on the annular main body part, the lugs projecting into the receiving or mounting space. Preferably, the fastening lugs with through-openings for the fastening elements are also formed by the laminations of the stator main body, in particular by the total number of laminations in the lamination stack.

Conveniently, the motor carrier has an axially raised sealing wall or mounting and/or sealing groove in relation to the motor axis on the carrier side assigned to the electronics compartment. An electronics compartment lid that closes the electronics compartment has a lid base and a lid wall molded onto it and oriented axially in relation to the motor axis, which lid wall preferably forms at least one adhesive gap or sealing groove with the sealing wall of the motor carrier for receiving a potting compound (sealing compound) that seals the electronics compartment.

Other features which are considered as characteristic for the invention are set forth in the appended claims.

Although the invention is illustrated and described herein as embodied in an electric motor, in particular a radiator fan motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective, exploded view of a brushless electric motor in external rotor design, with a rotor and with a stator having a stator winding (rotating field winding) and with a motor carrier and with (phase) contact pins introduced sealingly therethrough into an electronics compartment for motor electronics (converter electronics);

FIG. 2 is a sectional view of the electric motor according to FIG. 1;

FIG. 3 is a perspective view of a detail of the stator of the electric motor with its stator main body with radially outwardly directed stator teeth and coils of the stator winding arranged thereon (without upper coil insulation), looking towards three connection contacts and (phase) contact pins contacted therewith;

FIG. 4 is a perspective view of a detail of the stator of the electric motor as shown in FIG. 3 with upper coil insulation in a different viewing direction of the contact pins and with a view of the radial lugs of the stator main body through which they pass;

FIG. 5 is a perspective view corresponding to FIG. 4, where the contact pins are in insulating pins of a lower coil insulation of the stator main body; and

FIG. 6 is an illustration showing a detail VI from FIG. 2 on a larger scale with the sealing feedthrough of the contact pin through the motor carrier into the electronics compartment.

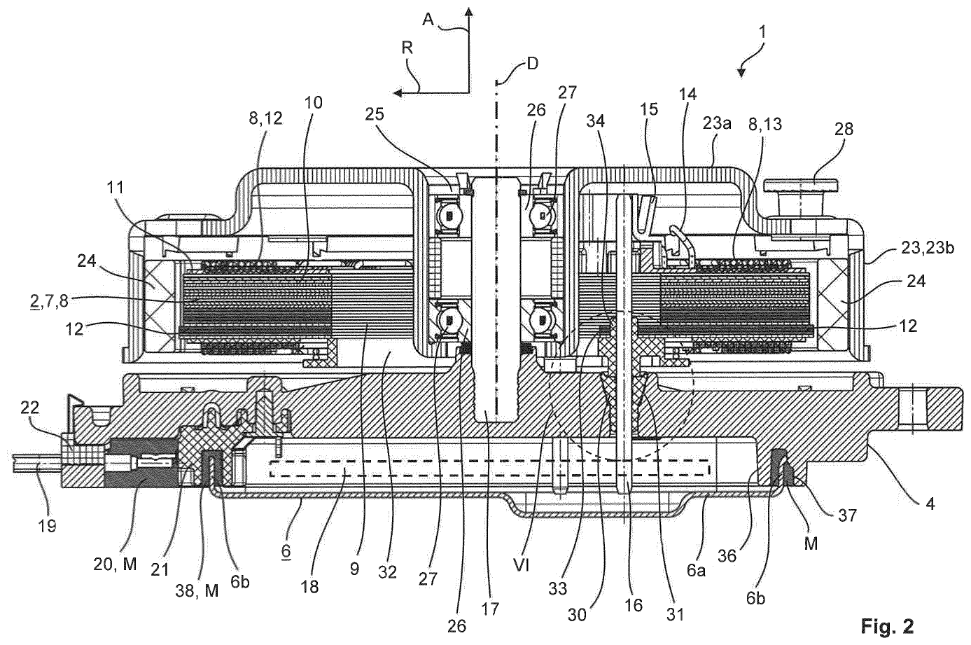

Corresponding parts and sizes are marked with the same reference signs in all figures. The specifications such as axial and radial refer to a motor axis (rotation axis) D indicated in FIG. 2 and refer to the axial and radial directions A and R, respectively, shown in FIG. 2.

### DETAILED DESCRIPTION OF THE INVENTION

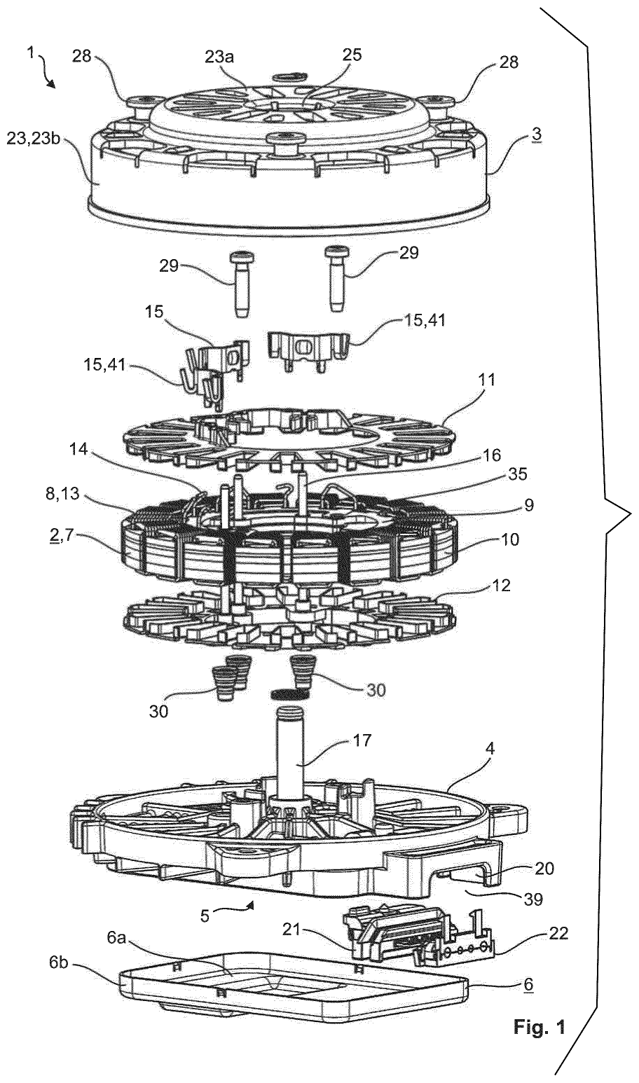

Referring now to the figures of the drawings in detail and first, particularly to FIGS. 1 and 2 thereof, there is shown an exploded view and a sectional view of an electric motor 1 configured as an external rotor, which is preferably intended and set up as a drive for a radiator fan of a motor vehicle. The electric motor 1 substantially has a stator 2 and a rotor 3 circulating around it about the rotation axis D as well as a (plate-like or plate-shaped) motor carrier 4, also referred to below as a support plate, with an electronics compartment 5, which can be closed with an electronics compartment lid 6. The motor carrier 4 is preferably a die-cast aluminum part. The electronics compartment lid 6, preferably made of aluminum or stainless steel, has a lid base 6a and a lid wall 6b molded thereon, which lid wall is preferably peripheral.

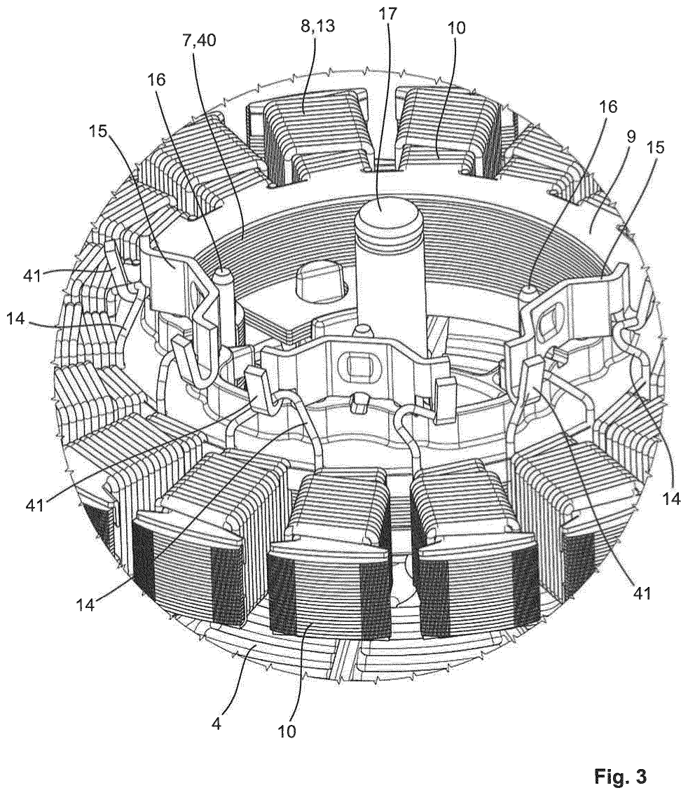

The stator 2 has a stator main body 7 and a stator or rotating field winding 8. The stator main body 7 is preferably formed from a number of laminations 40 (see FIG. 3) stacked to form a laminated core. The stator 2 or its stator main body 7 has an annular main body part 9 and radially outwardly directed stator teeth 10 molded onto the outer side.

Coil or winding insulation 11, 12 is provided on each of the two sides of the stator main body 7 or the laminated core and are hereinafter also referred to as the upper coil insulation 11 facing away from the motor carrier 4 and the lower coil insulation 12 facing the motor carrier 4. The coil insulations 11, 12, which are preferably made of a plastic, for example each produced as an injection-molded part, cover the stator main body 7 and, in particular, the stator teeth 10, in each case at or on one stator side. The coil insulations 11, 12 are formed in a star shape, correspondingly to the orientation of the stator teeth 10, with an inner radius matched to the hollow-cylindrical shape of the receiving or assembly space 32. The stator main body 7 of the stator 2 covered by the coil insulations 11, 12 is provided with the stator winding 8, which is preferably made up of interconnected coils 13, which in turn are wound onto the individual stator teeth 10.

In FIG. 1, the two coil insulations 11, 12 are shown separately to make them recognizable, while FIG. 2 shows the actual assembly situation of the stator main body 7 provided with the coil insulations 11, 12. The stator main body is wound with the coils 13 of the stator winding 8 with the coil insulations 11, 12 interposed. Winding loops or winding ends 14 of the stator winding 8 are electrically conductively connected to busbar-like connection contacts 15, which connection contacts 15 are contacted, for example (laser) welded, with contact pins 16.

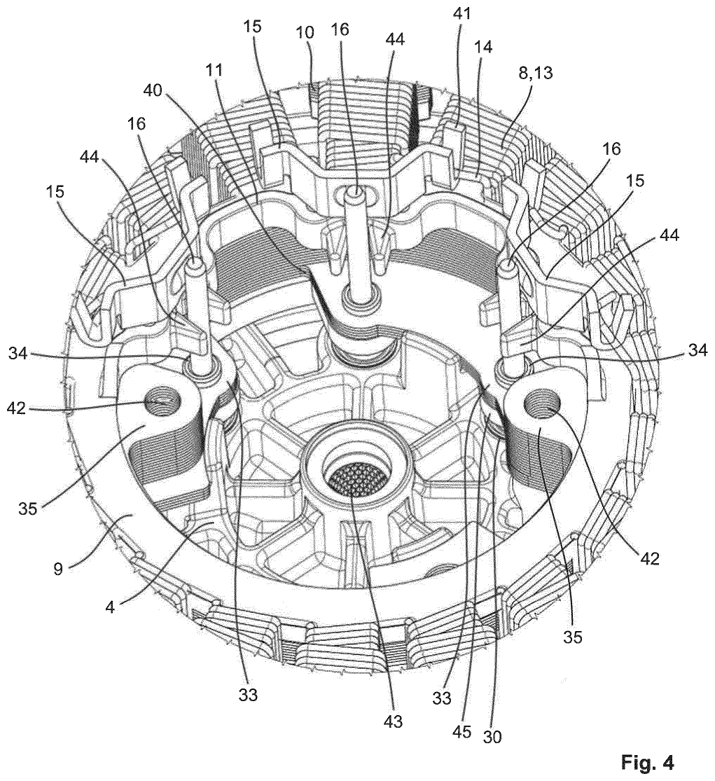

The motor carrier 4 has, on its support side assigned to or facing the stator 2 and the rotor 3, a rigid rotation axis in the form of an axle bolt 17, which is received in a corresponding bolt receptacle, denoted by 43 in FIG. 4, of the motor carrier 4 in a rotationally fixed manner, for example is cast or compressed therein. The axle bolt 17 effectively forms the rotation axis or motor axis D of the electric motor 1 or rotor 3.

On the carrier side opposite the stator 2 and the rotor 3, the electronics compartment 5 for the motor electronics 18 is provided in the motor carrier 4. The electronics compartment 5 opens at one end into a plug compartment 20, into which two plug parts 21, 22 (an inner plug part 21 and an outer plug part 22) provided for contacting with a connection cable 19 (FIG. 2) can be inserted or are inserted in the exemplary embodiment. When the electric motor 1 is installed, the electronics compartment 5 is sealed, in particular in a moisture-proof manner, with the electronics compartment lid 6.

The rotor 3 has a pot-like rotor housing 23 with a housing base 23a and a housing wall (ring or housing wall) 23b oriented in axial direction A. Permanent magnets 24 are arranged on the inside of this wall. The rotor housing 23 has a central, preferably hollow-cylindrical housing portion deep-drawn in the housing base 23a as a bearing housing 25 for two roller or ball bearings 26, which are axially spaced—in relation to the rotation axis D—in the exemplary embodiment. Their unspecified outer rings are held in the deep-drawn bearing housing 25 so that they cannot rotate, and their unspecified inner rings are firmly connected to the axle bolt 17, wherein bearing balls 27 are arranged between the outer and inner rings (FIG. 2).

Mounting elements 28, for example screws, correspond to the rotor housing 23 preferably for fastening a fan wheel, not shown, of the radiator fan to the rotor 3. Fastening elements 29, for example screws or bolts, are provided for fastening the stator 2 to the motor carrier 4.

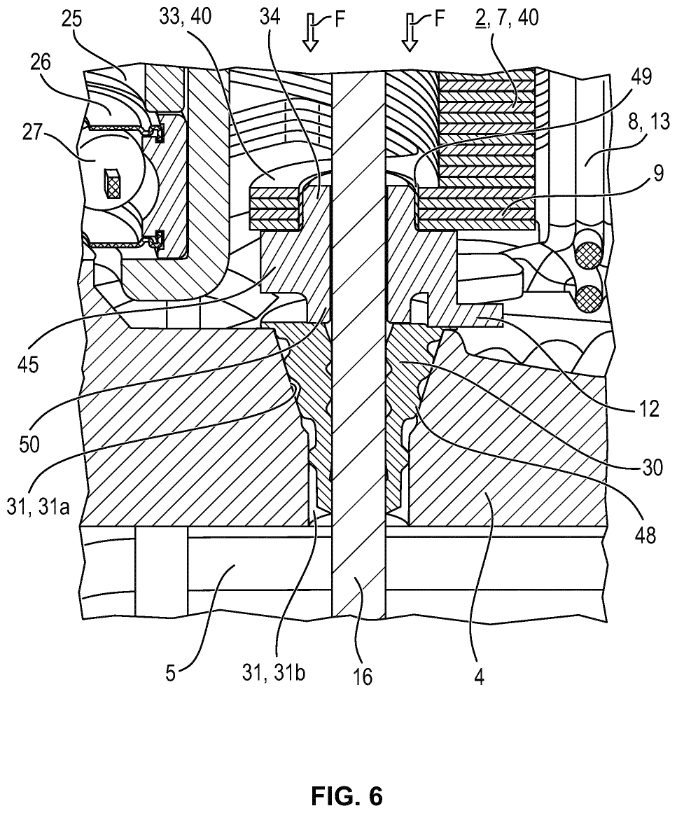

As can be seen in FIG. 2 and as is comparatively clear in FIG. 6, sleeve-like or plug-like sealing elements 30 are provided for the contact pins 16 in order to seal the contact pins 16 relative to the motor carrier 4. For this purpose, the motor carrier 4 has corresponding through-openings 31, in which the sealing elements 30, through which the contact pins 16 pass, fit sealingly. The contact pins 16 protrude into the electronics compartment 5 in order to make contact with the motor or inverter electronics 18. In the exemplary embodiment, a three-phase stator winding 8 is provided, so that correspondingly three contact pins 16 connected via the connection contacts 15 as contact elements to the coils 13 of the stator or rotating field winding 8 are provided as phase connections for the stator or rotating field winding 8 and are guided to the motor electronics 18 and (electrically) contacted there.

As can be seen in FIG. 2 and in particular in FIGS. 3 to 5, the annular main body part 9 of the stator main body 7 forms a receiving or mounting space 32, in which the axle bolt 17 oriented in the axial direction A is located as the rotation axis D for the rotor 3. In addition, the contact pins 16 serving as phase connections are located in this receiving space 32. Furthermore, a radial lug 33 serving as a feedthrough for the respective contact pin 16 projects into the receiving space 32.

The radial lug 33 is formed from some of the laminations of the stator main body 7 and has a through-opening denoted in greater detail in FIG. 6. An insulating dome or insulating pin 34 projects, preferably form-fittingly, into the radial lug 33 or its through-opening 49 (FIG. 6). The insulating dome 34 is penetrated by the respective contact pin 16. The insulating dome or insulating pin 34 is a component of the lower coil insulation 12 in FIGS. 1 and 2, and is therefore preferably molded onto it.

With reference to FIGS. 1 and 4, at least one further fastening or radial lug 35 is also formed by the stator main body 7 of the stator 2 or by its lamination stack and projects into the receiving space 32. The fastening or radial lug 35 has a through-opening 42 (FIG. 4) for the respective fastening element 29 and is used with the latter to hold the stator 2 on the motor carrier 4, in particular for screw fastening.

The electronics compartment 5 is surrounded by an axially raised sealing wall 36. The sealing wall 36 on the carrier side has a retaining groove 37. In the assembled state, the preferably circumferentially closed cover wall 6b of the electronics compartment cover 6 engages in the carrier-side receiving groove 37. In other words, the electronics compartment lid 6 is seated with its lid wall 6b in the carrier-side receiving groove 37.

With the electronics compartment lid 6 seated in the receiving groove 37, the receiving groove 37 is filled with an initially liquid or viscous, hardenable potting or sealing compound M, for example. As shown in FIG. 2, the radially inner plug part 21 forms a boundary wall between the electronics compartment 5 and the plug compartment 20 on one end face of the electronics compartment 5 in the region of the carrier-side sealing groove or receiving groove 37. On the other hand, a receiving groove 38 on the plug part side is provided in or on this inner plug part 21, the dimensions of which are adapted to the carrier-side receiving groove 34.

The receiving groove 38 on the plug part side is aligned with the receiving groove 37 on the carrier side and, together with the latter, forms a circumferentially closed receiving groove for the cover wall 6b of the electronics compartment cover 6. Opposite the inner plug part 21, the plug compartment 20 is basically wall-free. The radially outer plug part 22 sits in this end-face wall gap 39 (FIG. 1), thus forming a plug compartment 20 that is also closed all the way round.

FIG. 3 shows a detail of the stator 2 of the electric motor 1 with its stator main body 7 formed from stacked laminations 40 with the annular main body part 9 and the stator teeth 10 molded onto it on the outer circumference and directed outwards in the radial direction R and with the coils 13 of the stator winding 8 arranged on it without upper coil insulation 11 with a view of the three connection contacts 15 and the (phase) contact pins 16 contacted therewith. The connection contacts 15 have, preferably flexible, contact lugs (bending lugs) 41, in or on which the winding loops or winding ends 14 are contacted, for example by means of laser welding and/or clamp contacting.

FIG. 4 shows a similar representation to FIG. 3 of the stator 2 of the electric motor 1 with the stator main body 7 formed from the stacked laminations 40 with the coils 13 of the stator winding 8 arranged thereon and with the upper coil insulation 11 with a view into the receiving or mounting space 32 of the three (phase) contact pins 16 contacted with the connection contacts 15. Shown are the fastening or radial lugs 35 formed by the stator main body 7 or by the laminations 40 of the lamination stack or laminated core with the through-openings 42 for the fastening elements 29 for holding the stator 2 on the motor carrier (on the motor carrier plate) 4. In addition, the bolt receptacle 43 in the motor carrier 4 for the axle bolt 17 is shown.

FIG. 4 also shows holding or positioning clamps 44, in particular fork-shaped clamps, in or with which the contact pin 16 is held or fixed in a desired position for contacting the respective connection contact 15. The fork-shaped clamps 44 are molded onto the upper coil insulation 11 or its inner radius, in particular on the inner circumference, and protrude into the receiving or mounting space 32 in the radial direction R.

FIG. 4 also shows the radial lugs 33 provided on the stator main body 7 or formed from its laminations 40 and projecting inwards in the radial direction R into the receiving or mounting space 32 with the insulating domes or insulating pins 34 seated therein. These are molded onto radially inwardly directed lugs 45 of the lower coil or winding insulation 12. In FIG. 6, the radial lugs 33 have a through-opening denoted 49 for the associated contact pin 16.

In the assembled state with the stator 2 attached to the motor carrier 4, in particular screwed to it, the sealing elements 30 through which the contact pins 16 pass are subjected to a pressure or pressing force F (FIG. 6). This is generated by the stator main body 7 via its radial lugs 33 and/or via the lower coil insulation 12 or its lugs 45 with the molded-on insulating pins 34. This mechanically pretensions the sealing elements 30. No (further) components or parts are therefore required for this, which saves corresponding costs.

It can be seen that the radial lugs 33 are only formed by a number of laminations 40 of the stator main body 7. This number is smaller than the total number of laminations 40 of the stator main body 7. For example—in relation to the total number-such lug portions are formed on 20% of consecutive laminations 40, which form the radial lugs 33 for the corresponding contact pin 16 in the lamination stack (laminated core) of the stator main body 7.

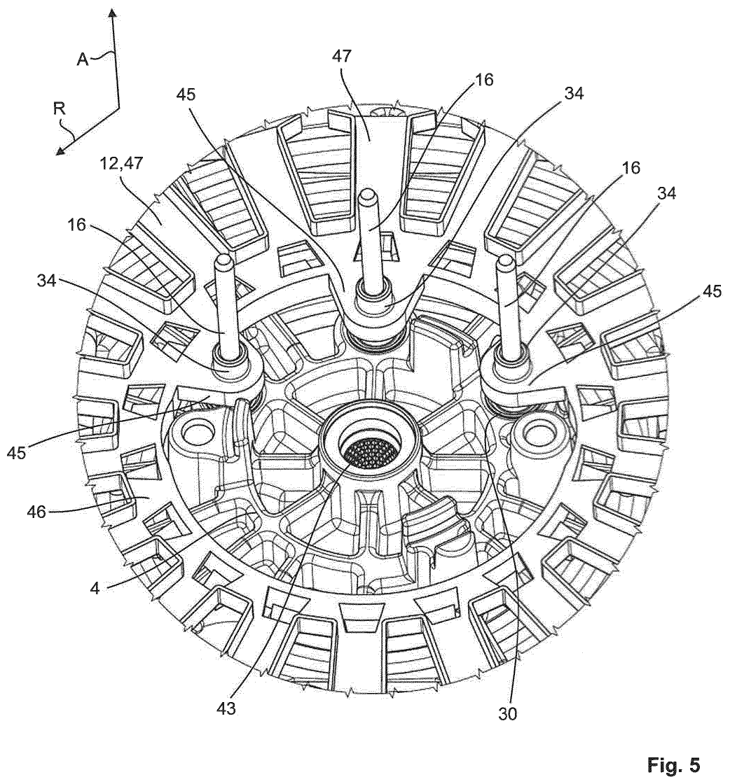

FIG. 5 shows a view of the lower coil insulation 12 with its lugs 45 projecting into the mounting space 32 and oriented in the radial direction R. The insulating pins 34, which are oriented in the axial direction A and thus axially raised, are molded onto these lugs and are penetrated by the respective contact pin 16. The coil insulation 12 is formed from an inner ring 46 and tooth caps 47 molded onto it on the outer circumference and extending outwards in a star shape in the radial direction R to cover the stator teeth 10. The insulating pins 34 with the contact pins 16 passing through them are seated in the radial lugs 33 of the stator main body 7.

FIG. 6 shows an enlarged detail from FIG. 2 in the region of one of the sealing elements 30 for the phase contact pin 16 inserted through it and guided into the electronics compartment 5. The through-openings 31 of the motor carrier 4 provided to receive the sealing elements 30 for the contact pins 16 have a conical or cone-shaped (frustoconical) opening portion 31a, which tapers towards the electronics compartment 5. The conical opening portion 31a merges into a (hollow-) cylindrical opening portion 31b of the through-opening 31 of the motor carrier 4, which opens into the electronics compartment 5.

The respective sealing element 30 has a number of, preferably circumferential, in particular axially spaced-apart, radial ribs 48 on the outer circumference. The respective sealing element 30 is preferably conical or frustoconical in shape. In particular due to the conical shape or the frustoconical design of the carrier-side through-opening 31 or the sealing element 30 and preferably by means of its radial ribs 48, a reliable seal in the manner of a labyrinth seal is achieved for the contact pin 16.

The radial lug 33 formed by the stator main body 7 or its laminations 40 has the through-opening 49, in which the insulating pin 34 molded onto the lug 45 of the lower coil insulation 12 is form-fittingly seated. In the assembly state shown, the lugs 45 of the coil or winding insulation 12 rest on the one hand against the radial lugs 33 arranged on the annular main body part 9 of the stator main body 7. On the other hand, the lugs 45 of the coil or winding insulation 12 rest against the respective sealing element 30 via hollow-cylindrical molded parts 50 molded onto them in the exemplary embodiment. As a result, a pressure or pressing force F generated as a result of the attachment of the stator 2 to the motor carrier 4 acts on the respective sealing element 30, so that the latter is purposefully mechanically prestressed.

In summary, the invention relates to an electric motor 1 with a motor carrier 4 with an electronics compartment 5 and with a stator 2 fastened to the motor carrier 4 with a stator winding 8 and with a rotor 3 circulating around the stator 2. The stator 2 has a stator main body 7 with an annular main body part 9 and radially outwardly directed stator teeth 10. A coil or winding insulation 12 is arranged on the stator main body 7. The main body part 9 forms a receiving or mounting space 32, in which contact pins 16 are arranged which are contacted or can be contacted with the stator winding 8 and which are guided into the electronics compartment 2 via sealing elements 30 in through-openings 31 of the motor carrier 4. The sealing elements 30 are mechanically prestressed by means of the stator 2 fastened to the motor carrier 4 or by means of the stator main body 7 and/or by means of the coil or winding insulation 12.

The claimed invention is not limited to the exemplary embodiments described above. Rather, other variants of the invention can also be derived by a person skilled in the art from this within the scope of the disclosed claims without departing from the subject manner of the claimed invention. In particular, all the individual features described in conjunction with the various exemplary embodiments can also be combined in other ways within the scope of the disclosed claims without departing from the subject matter of the claimed invention.

In addition, the solution described can be used not only in the specific application shown, but also in a similar design in other motor vehicle applications, such as in door and tailgate systems, in window lifters, in adjustable seat and interior systems and in electric drives.

The following is a summary list of reference numerals and the corresponding structure used in the above description of the invention:
1 electric motor
2 stator
3 rotor
4 motor carrier/carrier plate
5 electronics compartment
6 electronics compartment lid
6a lid base
6b lid wall
7 stator main body
8 stator/rotating field winding
9 main body part
10 stator tooth
11 (upper) coil insulation
12 (lower) coil insulation
13 coil
14 winding loop/winding end
15 connection contact
16 contact pin
17 axle bolt
18 motor/converter electronics
19 connection cable
20 plug compartment
21 (inner) plug part
22 (outer) plug part
23 rotor housing
23a housing base
23b housing/ring wall
24 permanent magnet
25 housing portion/bearing housing
26 roller/ball bearing
27 bearing ball
28 mounting element
29 fastening element
30 sealing element
31 through-opening
31a conical/cone-shaped opening portion
31b cylindrical opening portion
32 receiving/mounting space
33 radial lug
34 insulating dome/pin
35 fastening/radial lug
36 sealing wall
37 (carrier-side) receiving groove
38 (plug-side) receiving groove
39 wall gap
40 lamination
41 contact/bending lug
42 through-opening
43 bolt receptacle
44 holding/positioning clamp
45 lug
46 inner ring
47 tooth cap
48 radial ribs
49 through-opening
50 molded part
A axial direction
D motor/rotation axis
F (pressure/pressing) force
M potting/sealing compound
R radial direction

1. An electric motor, comprising:
sealing elements;
a motor carrier having an electronics compartment for accommodating motor electronics, said motor carrier having through-openings formed therein and said sealing elements being disposed in said through-openings;
a stator fastened to said motor carrier and having a stator winding, a stator main body with an annular main body part and radially outwardly directed stator teeth;
a coil or winding insulation disposed on a side of said stator facing said motor carrier or on said side of said stator facing said motor carrier and on a side facing away from said motor carrier on said stator main body thereof;
said annular main body part of said stator main body forms a receiving or mounting space, in which axially oriented contact pins are disposed which make contact or can make contact with said stator winding and are guided into said electronics compartment via said sealing elements in said through-openings of said motor carrier, wherein said sealing elements are mechanically pretensioned by means of said stator fastened to said motor carrier or by means of said stator main body and/or by means of said coil or winding insulation; and
a rotor circulating around said stator about a rotation axis.

2. The electric motor according to claim 1, wherein said stator main body, on said annular main body part, has radial lugs aligned with said through-openings of said motor carrier, which said radial lugs each have a through-opening formed therein for an associated one of said axially oriented contact pins.

3. The electric motor according to claim 2, wherein:
said stator main body is formed as a laminated core from a first number of stacked laminations; and
said radial lugs are formed by a second number of said laminations, wherein said second number is smaller than a total number of said laminations of said stator main body.

4. The electric motor according to claim 2, wherein said coil or winding insulation has a number of axially raised insulating pins corresponding to a number of said axially oriented contact pins, said axially raised insulating pins protrude into said receiving or mounting space formed by said annular main body part of said stator main body and through which a respective one of said axially oriented contact pins passes.

5. The electric motor according to claim 4, wherein said axially raised insulating pins of said coil or winding insulation are assigned to said radial lugs of said stator main body and sit in said through-openings of said radial lugs.

6. The electric motor according to claim 4, wherein:
said coil or winding insulation has radially inwardly directed lugs; and
said axially raised insulating pins are molded onto said radially inwardly directed lugs of said coil or winding insulation.

7. The electric motor according to claim 6, wherein said radially inwardly directed lugs of said coil or winding insulation lie against said radial lugs disposed on said annular main body part of said stator main body and against associated said sealing elements directly or via molded-on hollow-cylindrical molded parts.

8. The electric motor according to claim 1, wherein:
said through-openings of said motor carrier provided to accommodate said sealing elements for said axially oriented contact pins have a conical or cone-shaped opening portion that tapers towards said electronics compartment; and/or
each of said sealing elements has a plurality of radial ribs on an outer circumference; and/or
each of said sealing elements is conical or frustoconical shaped.

9. The electric motor according to claim 8, wherein each of said through-openings of said motor carrier has a cylindrical opening portion which adjoins said conical or cone-shaped opening portion.

10. The electric motor according to claim 1,
further comprising connection contacts; and
wherein said stator winding has at least one of winding ends or winding loops, said axially oriented contact pins are contacted with said connection contacts which are electrically conductively connected to said winding ends or said winding loops.

11. The electric motor according to claim 1,
further comprising fastening elements, wherein said stator being fastened to said motor carrier by means of said fastening elements while at a same time generating a pretension on or for said sealing elements through which said axially oriented contact pins pass; and/or
wherein said stator main body has fastening lugs with through-openings formed therein for said fastening elements on said annular main body part, said fastening lugs projecting into said receiving or mounting space.

12. The electric motor according to claim 1, wherein the electric motor is a radiator fan motor of a motor vehicle.

13. The electric motor according to claim 10, wherein:
said axially oriented contact pins are welded with said connection contacts; and
said connection contacts are busbar-shaped connection contacts.

14. The electric motor according to claim 11, wherein said fastening elements are screws.
